(19) United States
(12) Patent Application Publication
(10) Pub. No.: US 2025/0077274 A1
(43) Pub. Date: Mar. 6, 2025

(54) ARTIFICIAL INTELLIGENCE SCHEDULER FOR TASK-EXECUTION SYSTEMS

(71) Applicant: Dell Products L.P., Round Rock, TX (US)

(72) Inventor: Michael Marrotte, Windermere, FL (US)

(21) Appl. No.: 18/461,694

(22) Filed: Sep. 6, 2023

(51) Int. Cl. G06F 9/48

(52) U.S. Cl. CPC G06F 9/4881

(57) ABSTRACT

The technology described herein is directed towards an artificial intelligence scheduler for real-time task execution systems, including an implementation based on a recurrent learning model. In one implementation, the model incorporates a deep Q-network and proximal policy optimization to learn efficient scheduling policies for real-time systems. The scheduler can optimize for various real-time system aspects, including avoiding deadlocks, minimizing blocking, avoiding priority inversion, and reducing starvation. The artificial intelligence scheduler learns from actual system experience data to regularly improve scheduling policies and/or adapt to changing system requirements.

### BACKGROUND

Real-time systems with multiple CPUs and multiple unit resources that execute tasks (that make up jobs) are becoming increasingly prevalent in various domains, including high-performance computing, datacenters, and autonomous systems. Such real-time systems are typically characterized by strict timing constraints that need timely execution of tasks using one or more processors and other resources, where tasks are independent units of work that are executed to perform workloads. A task, or group of tasks corresponding to a job, can have critical sections (segments of code requiring exclusive access to shared resources), can have attributes such as execution time, release time, and a deadline, and can be prioritized based on importance and urgency. Scheduling of tasks is a significant consideration so that jobs complete in a timely manner; for example, preemptive scheduling allows a higher-priority job to interrupt and suspend the execution of a lower-priority job, with the lower-priority job resuming once the higher-priority job completes.

Scheduling of tasks needs to take into consideration a number of issues, including avoiding per-CPU deadlock, where tasks are unable to proceed due to cyclic dependency on shared resources, blocking, in which a higher-priority task is blocked by lower-priority task holding a shared resource, and priority inversion, in which a higher-priority task is indirectly delayed by a lower-priority task. For each CPU, there are various scheduling approaches such as having static task priorities based on periods, or basing priorities on deadlines. Multiple CPU scheduling approaches can include global scheduling, in which a priority-driven scheduler manages CPUS, partitioned scheduling, in which tasks are statically assigned to CPUs, or a combination of global and partitioned scheduling.

Real-time systems thus involve various concepts, scheduling techniques, and challenges, including with respect to single-unit resources (shared resources that can be used by only one task at a time) and multi-unit resources (shared resources with multiple instances, allowing concurrent usage by multiple tasks up to the available instances), and critical sections that can cause deadlock, and preemption. These concepts correspond to potential issues in both single unit resource environments and multiple unit resource environments.

### BRIEF DESCRIPTION OF THE DRAWINGS

The technology described herein is illustrated by way of example and not limited in the accompanying figures in which like reference numerals indicate similar elements and in which:

FIG. 1 depicts an example block diagram representation of an example system/architecture for an artificial intelligence scheduler for a task-execution system, in accordance with various aspects and implementations of the subject disclosure.

FIG. 2 is an example block diagram representation of a recurrent learning model that updates policy data for use by artificial intelligence schedulers in task scheduling and resource allocation, in accordance with various aspects and implementations of the subject disclosure.

FIG. 3 is an example block diagram representation of a recurrent learning model with a deep-Q network and proximal policy optimization for updating policy data, in accordance with various aspects and implementations of the subject disclosure.

FIG. 4 is an example block diagram representation of a deep-Q network that outputs action values for use by artificial intelligence schedulers in task scheduling and resource allocation, in accordance with various aspects and implementations of the subject disclosure.

FIG. 5 is an example block diagram representation of proximal policy optimization that outputs policy data for use by artificial intelligence schedulers in task scheduling and resource allocation, in accordance with various aspects and implementations of the subject disclosure.

FIG. 6 is a flow diagram showing example operations related to obtaining, based on state data and learned scheduling policy, task-related output from a trained scheduler model, in accordance with various aspects and implementations of the subject disclosure.

FIG. 7 is a flow diagram showing example operations related to scheduling prioritized tasks and executing the scheduled tasks, in accordance with various aspects and implementations of the subject disclosure.

FIG. 8 is a flow diagram showing example operations related to executing a group of tasks based on the scheduling policy data and respective task parameter data, in accordance with various aspects and implementations of the subject disclosure.

FIG. 9 is a block diagram representing an example computing environment into which aspects of the subject matter described herein may be incorporated.

FIG. 10 depicts an example schematic block diagram of a computing environment with which the disclosed subject matter can interact/be implemented at least in part, in accordance with various aspects and implementations of the subject disclosure.

### DETAILED DESCRIPTION

Various aspects of the technology described herein are generally directed towards an artificial intelligence (AI)-based real-time scheduling architecture, including for multi-CPU systems with single-unit and multiple-unit resources. The architecture includes various components that work together to ensure efficient scheduling and resource allocation, while addressing challenges of real-time systems.

In one example implementation, a global AI scheduler manages high-level resource allocation, and is coupled to a local AI scheduler to manage task scheduling at the CPU level. In turn, the local AI scheduler is coupled to a resource allocation module to allocate resources to tasks according to the AI-based scheduling.

In one example implementation, the architecture incorporates a recurrent learning model that uses a deep-Q network and proximal policy optimization network to learn and output efficient scheduling policy data. The architecture uses monitoring, data analysis, and algorithm selection to improve scheduling policies over time for a given real-time task-execution system.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimization,” “optimize” or “optimal” and the like (e.g., “maximize,” “minimize” and so on) only represent objectives to move towards a more optimal state, rather than necessarily obtaining ideal results. Thus, an “optimal action” for example can be the best estimated action from a set of available candidate actions, even though a more optimal action may exist that is not in the candidate action set.

Aspects of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

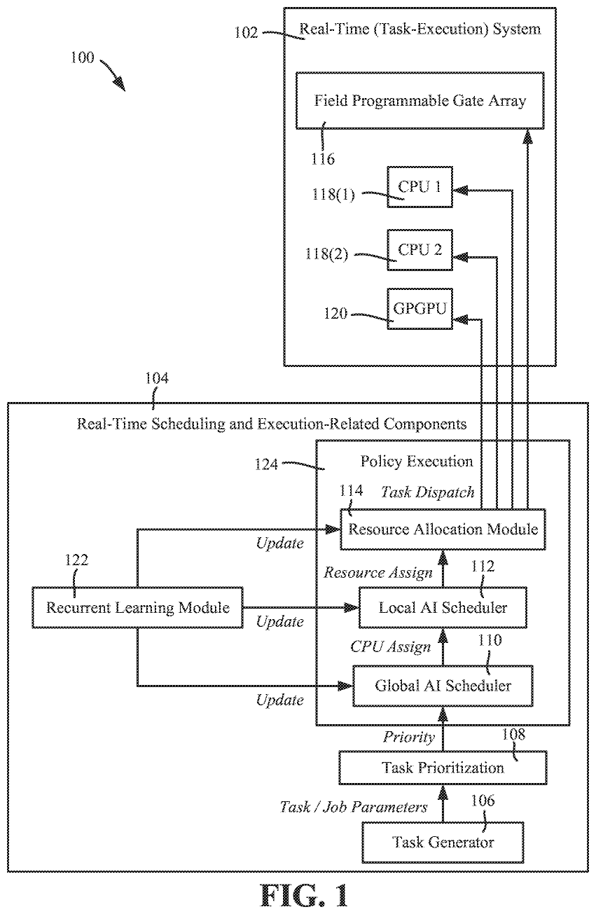

FIG. 1 shows an example artificial intelligence-based real-time scheduling architecture 100, such as designed for a multiple CPU real-time system 102 with single-unit or multi-unit resources. The example architecture 100 comprises the real-time system 102 and real-time scheduling and execution-related components 104 that work together to ensure efficient scheduling and resource allocation for tasks/jobs, while addressing the various challenges of the real-time system 102. Note that as used herein, a task is a unit of execution, in which a job is made up of one or more related tasks; it is feasible for a job to be executed by executing its tasks together, which sometime can occur in parallel. Thus, as used herein, a “task” is executed whether or not part of a larger job that is performed via its executed tasks. Note however that a job can have type data, priority data, and deadline data which relate to its separate tasks.

An artificial intelligence-based real-time scheduling workflow can be generally divided into task/job generation, prioritization and scheduling, and execution. In task generation, users or external systems generate a task or job, which includes various parameters such as the task type, required resources, priority, and deadline. A task generator (module) 106 receives these parameters and generates the task or job with unique identifiers, which are sent to the task prioritization module 108.

With respect to simulation and training, task generation in the development and testing phases uses the task generator 106 to simulate incoming workloads in a real-time system; the task generator 106 generates tasks with attributes such as execution time, release time, deadline, and resource requirements, reflecting various aspects of real-world tasks. With respect to usage in an actual real-time system, tasks can originate from different sources, such as sensors, user inputs, or other system components, depending on a given task-execution system's specific application (e.g., a real-time control system versus a network optimization system).

In prioritization and scheduling, the task prioritization module 108 receives the tasks (which can be part of one or more jobs) and their associated parameters from the task generator module 106. The task prioritization module 108 prioritizes the tasks/jobs based on their type, priority, and deadline. The task prioritization module 108 assigns priorities to tasks based on factors including deadlines, resource requirements, and the system's current state, including, for example, which resources are available or will become available at a known future time. In general, the task prioritization module 108 ensures that higher-priority tasks are executed before lower-priority tasks, satisfying real-time constraints. Once prioritized, the prioritized tasks are sent to a global artificial intelligence (AI) scheduler module 110, which is responsible for scheduling the tasks on the available resources.

A global AI scheduler (module) 110 generally oversees the entire system and allocates tasks to CPUs (via local AI schedulers) based on their priorities and the available resources. The local AI scheduler(s) (e.g., module) 112 are responsible for managing individual CPUs, including determining the execution order of tasks assigned to them. The global AI scheduler 110 and the local AI scheduler(s) 112 schedulers use AI models to make informed decisions, considering the system's state data and learned scheduling policy data. More particularly, the global AI scheduler 110 uses AI-based techniques, such as reinforcement learning and/or deep learning, to decide which resources to allocate to which tasks/jobs. The decision is based on various factors, including the availability of resources, priority of tasks/jobs, and the resource requirements of each task/job. In the example implementation of FIG. 1. the local AI scheduler 112 receives the schedule from the global AI scheduler 110 and assigns (via a resource allocation module 114 in this example) CPUs and/or other processors to the tasks/jobs according to their resource/timing requirements.

FIG. 1 also shows a resource allocation module 114, which manages single-unit and multiple-unit resources in the system, allocating the resources to tasks based on the tasks' requirements and priorities. The resource allocation module 114 aims to maximize resource utilization, based on policy data, while avoiding issues like deadlock, blocking, and priority inversion. A field programmable gate array 116, two CPUs 118(1) and 118(2) and general purposes graphics processing unit (GPGPU) 120 are shown as coupled to the resource allocation module 114 in this example. Memory and other resources (e.g., network resources/bandwidth) can also be part of the scheduled utilization.

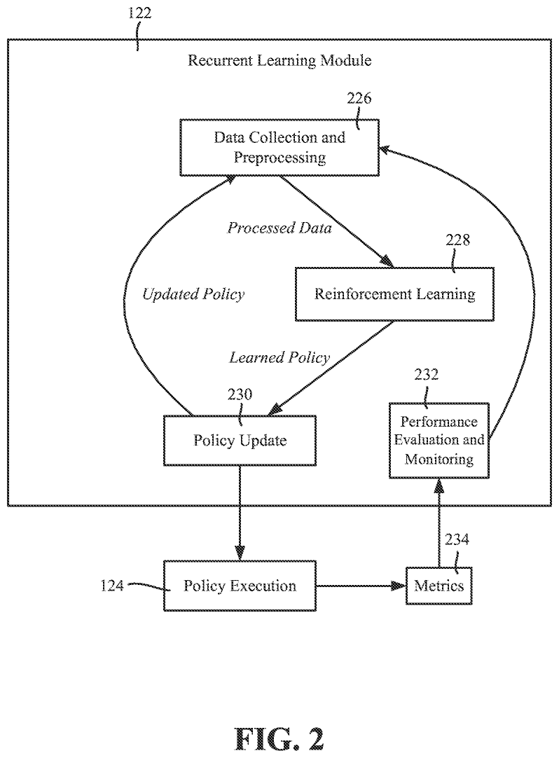

With respect to execution, the scheduled tasks are executed on their assigned resources. The resource allocation module 114 receives the tasks/jobs and their assigned resources from the local AI scheduler module 112. That is, the resource allocation module 114 allocates the resources to the tasks/jobs and dispatches the tasks/jobs to the assigned resources for execution. A recurrent learning module 122 (further described with reference to FIG. 2) monitors the execution of the tasks/jobs and provides policy updates to the global and local AI schedulers 110 and 112, respectively, as well as the resource allocation module 114, to regularly improve the scheduling and resource allocation decisions. As shown in FIG. 1, the global scheduler1 110, the local AI scheduler 112 and the resource allocation module 114 can be collectively referred to as a policy execution module 124.

The workflow ends when all tasks/jobs are completed, or the deadline(s) of the tasks/jobs have passed. The AI-based real-time scheduling workflow improves the scheduling and resource allocation decisions of real-time systems, leading to better system performance, reliability, and efficiency. By automating the scheduling and resource allocation decisions, the AI-based real-time scheduling workflow allows developers to focus on designing and implementing other system features rather than spending time on scheduling.

The example AI-based real-time scheduling architecture 100 addresses the challenges of multi-CPU systems with single-unit and multi-unit resources, offering efficient scheduling and resource management. By incorporating AI models as described herein, including reinforcement learning, the architecture 100 can significantly improve the performance and reliability of real-time systems.

Turning to training versus actual operation, the distinction between the task generator for simulation and training purposes and the task generator from actual task sources (e.g., normalized sensor data or the like) in deployed systems correlate to the architecture's applicability in real-world scenarios.

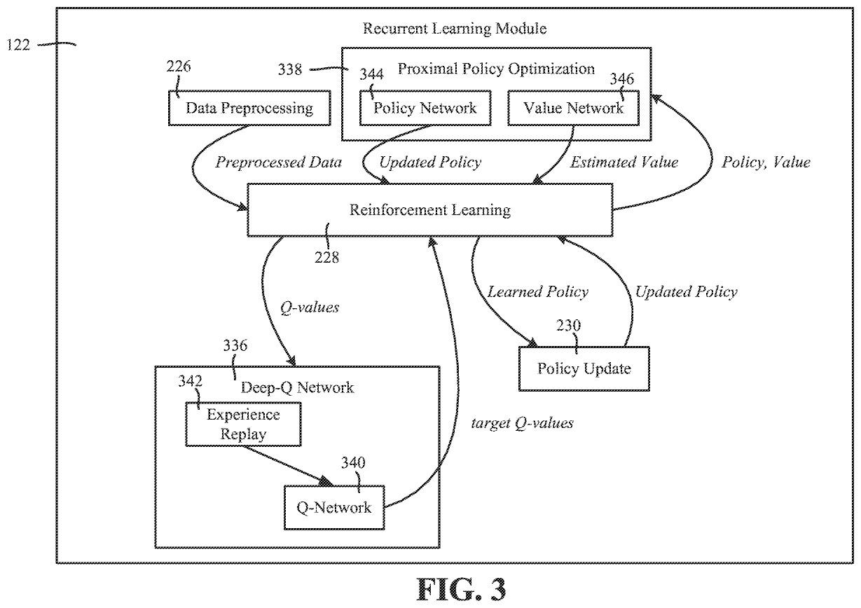

FIGS. 2 and 3 show details of an example recurrent learning module 122 that uses reinforcement learning algorithms (e.g., deep-Q networks and proximal policy optimization) to continuously learn and update the scheduling policy based on the system's performance. The recurrent learning module 122 interacts with the global and local AI schedulers as well as the resource allocation module, providing them with updated policy data to make better-informed scheduling and resource-allocation decisions.

FIG. 2 shows subcomponents of the example recurrent learning module 122, such as including, but not limited to, a data collection and preprocessing component 226, reinforcement learning 228, and policy update 230. These example subcomponents work together to enable the recurrent learning module 122 to learn and adapt to changes in the environment over time.

In general, the data preprocessing subcomponent 226 takes in the raw data from the environment and preprocesses it to make it suitable for learning. The reinforcement learning subcomponent 228 learns an optimal action in each situation using the preprocessed data. The policy update subcomponent 230 updates the policy based on the learned optimal action. The recurrent learning module 122 uses the optimal action to determine the optimal policy, which is a set of rules that determine the optimal action in any given situation. The optimal policy can be a function that maps the state of the environment to the optimal action.

In one example implementation, the recurrent learning module 222 needs a generally regular or continuous stream of data to update its policy data. The data collection and preprocessing component 226 collects data from various sources, preprocesses the data, and makes the preprocessed data available for use by the other components. The policy update module 230 is responsible for updating the policy data of the recurrent learning module 122 based on the data collected by the data collection component. The policy update module 228 may use various techniques such as reinforcement learning 228 and/or deep learning to update the policies.

As described with reference to FIG. 1, the policy execution module 124 is responsible for executing the policies generated by the policy update module 230. The policy execution module 124 may use techniques such as decision trees or rule-based systems to execute the policies.

In the example of FIG. 2, a performance evaluation and monitoring component 232 monitors the performance of the recurrent learning module 122 and evaluates the effectiveness of the policies generated by the recurrent learning module 122 over time. The performance evaluation and monitoring component 232 may use metrics 234, such as accuracy, precision, and recall, to evaluate the performance of the recurrent learning module 122.

By iteratively processing data, learning optimal actions, and updating the policy, the recurrent learning module 122 is able to learn an efficient scheduling policy that maximizes the expected reward, as further depicted in FIG. 3. More particularly, to learn the optimal policy in one example implementation, the recurrent learning module 122 uses reinforcement learning 228, which in the example of FIG. 3 includes or is coupled to a deep Q-network (DQN) 336 and proximal policy optimization (PPO) 338. The deep Q-network 336 and proximal policy optimization 338 algorithms use deep neural networks to approximate the optimal policy by minimizing the difference between the expected reward and the actual reward received.

Thus, FIG. 3 further shows additional details of one example implementation of the recurrent learning module 122, in which reinforcement learning algorithms such as deep Q-networks 336 and proximal policy optimization 338 learn efficient scheduling policies. In general, the recurrent learning module 122 learns by interacting with an environment and receives rewards for taking actions that result in desired outcomes. With respect to scheduling, the environment includes the set of available resources and tasks, and the actions correspond to allocating resources to tasks at specific times. The recurrent learning module 122 learns to identify an optimal action to take in each situation to maximize the expected reward; the optimal action is the action that results in the highest expected reward in the current situation.

As shown in the example implementation of FIG. 3, the recurrent learning module 122 utilizes two reinforcement learning algorithms to learn efficient scheduling policies, namely the deep Q-network 336 and the proximal policy optimization 338. The workflow of the recurrent learning module 122 includes data preprocessing 226, in which raw system data is preprocessed and transformed into the appropriate format needed for the reinforcement learning algorithms.

The lines in the diagram reflect the flow of data and updates between the different components. The “estimated value” line indicates the expected future reward for a given state, while the “policy” and “value” lines represent the probability of taking a specific action in a given state and the expected future reward for each state, respectively. The “target Q-value” line reflects the expected future reward for each action in a given state, and is used to update the DQN's Q-network 340. The “Q-values” line represents the expected future reward for each action in a given state output from the deep Q-network 336.

For reinforcement learning, the preprocessed data is fed into the deep Q-network 336 and proximal policy optimization 338, which learn and generate Q-values, policy, and value outputs. The Q-values output represent the expected future reward for each action in a given state. The target q-values are computed from the output of the deep Q-network 336 and are used to update the DQN's Q-network 340. To improve the stability of the training process, the deep Q-network 336 uses an experience replay buffer 342 to store past experiences and samples batches of experiences (e.g., obtained randomly by the Q-network 340 from the buffer during training). This helps to decorrelate the data and prevent the deep Q-network 336 from overfitting to recent experiences.

The policy output from a policy subnetwork 344 of the proximal policy optimization 338 represents the probability of taking a specific action in a given state. The value output from a value subnetwork 346 of the proximal policy optimization 338 represents the expected future reward for a given state. The policy and value outputs from the proximal policy optimization 338 are used to update the current policy (block 230) of the reinforcement learning algorithm 228. The updated policy data 228 is then fed back into the reinforcement learning algorithms, and the process repeats.

With respect to scheduling, the environment includes the set of available resources and tasks, and the actions correspond to allocating resources to tasks at specific times. The recurrent learning module 122 learns to identify an optimal action to take in each situation to maximize the expected reward; the optimal action is the action that results in the highest expected reward in the current situation.

By way of example of how the recurrent learning module 122 learns to avoid deadlock, consider two tasks, T1 and T2, each requiring two resources, R1 and R2, respectively. Initially. T1 holds R1 and requests R2, while T2 holds R2 and requests R1. Because T1 has R2 and is waiting for T2 to release R1, and T2 has R1 and is waiting for T1 to release R2, the system is in a deadlock state. However, the recurrent learning module can learn from this and avoid such situations in the future.

During the next iteration, the recurrent learning module 122 will assign T1 and T2 with priorities based on the current system state and learn from the previous iteration's deadlock. This learning process may involve updating the Q-values of the DQN and/or the policy of the PPO, depending on the learning algorithm(s) in use. The result of this learning process is that the recurrent learning module allocates tasks to resources in a manner that avoids deadlocks, thus maximizing system efficiency.

As with the deadlock example, the same approach can be used to optimize for other aspects of real-time systems, including bounded blocking, priority inversion, and starvation. For example, to optimize for bounded blocking, the system can be trained to predict and avoid situations where tasks are blocked for too long. Similarly, to optimize for priority inversion, the system can be trained to identify and avoid situations where high-priority tasks are blocked by low-priority tasks. To optimize for starvation, the system can be trained to ensure that each of the tasks receive a fair share of resources over time. Overall, the recurrent learning module can be used to learn efficient scheduling policies that consider a wide range of real-world constraints and objectives.

Thus, single-CPU scheduling concerns and approaches described herein include learning to avoid scheduling-related issues, including deadlock, blocking, and priority inversion. The general scheduling can be learn based on rate-monotonic scheduling (static priorities based on periods, e.g., for preemptive fixed-priority scheduling), deadline-monotonic scheduling (static priorities based on deadlines, e.g., for fixed-priority scheduling with arbitrary deadlines), and/or earliest deadline first (dynamic-priority scheduling based on job deadlines, e.g., for preemptive single-CPU scheduling).

Multi-CPU scheduling approaches can be adapted by AI learning for global scheduling (a single priority-driven scheduler manages all CPUs, allowing task migration), partitioned scheduling: (tasks are statically assigned to CPUs, reducing migration overhead) and/or semi-partitioned scheduling (combines global and partitioned scheduling, balancing their benefits). A first-come, first-served queue approach in which tasks are executed in the order they arrive can serve as a baseline for comparison.

In operation following training, the decision to update the schedulers and allocation module in the real-time scheduler is typically based on the performance of the system. The recurrent learning module 122 continuously (or at least occasionally) monitors the system and collects data about its performance, such as the response time and completion rate of tasks. Based on this data, the recurrent learning module 122 can determine whether the current scheduling policies and allocation decisions are effective, or whether they need to be updated.

If the recurrent learning module 122 detects that the system is not performing well, the recurrent learning module 122 can trigger an update to the schedulers and allocation module using the DQN 336 and/or PPO 338 algorithms. The specific algorithm used may depend on the nature of the performance issue detected and the characteristics of the system being controlled. For example, if the system is exhibiting unpredictable behavior or frequent changes in workload, the PPO algorithm 338 may be more suitable. On the other hand, if the system has stable workload patterns, using the DQN algorithm 336 may be more appropriate. In this way, the recurrent learning module 122 uses a combination of monitoring, data analysis, and algorithm selection to continuously improve the scheduling and allocation policies used in the real-time scheduler.

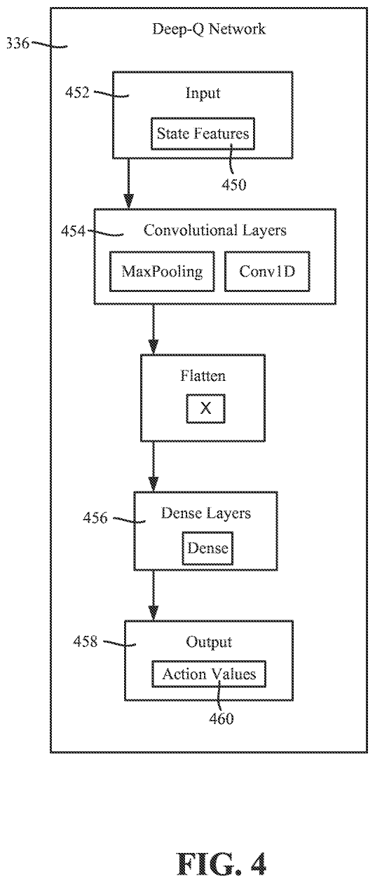

As depicted in the example of FIG. 4, the deep Q-network 336 is a variant of the Q-learning algorithm that uses deep neural networks to approximate the Q-function in reinforcement learning problems. The Q-function is a function that takes in a state and an action and outputs the expected total reward for taking that action in that state and following the optimal policy thereafter. The general goal of the deep Q-network is to learn this Q-function so that it can be used to make optimal decisions.

In the context of an artificial intelligence scheduler for real-time systems as described herein, the state is represented by a set of state features 450 that describe the current state of the system, such as the priority levels of the tasks, the remaining execution time of the tasks, and the resources currently being used. These features 450 are fed into the input layer 452 of the deep Q-network.

The deep Q-network architecture has multiple layers of convolutional (layer 454) and dense (layer 456) neural networks, which are responsible for extracting relevant features from the input data and predicting the Q-values for each possible action. The convolutional layers 454 are used to extract spatial features from the input data, while the dense layers 456 are used to learn high-level representations of the features.

The output layer 458 of the deep Q-network 336 produces the action values (Q-values) 460 for each possible action in the current state. The action with the highest Q-value is selected as the optimal action to take in that state.

During training, the deep Q-network 336 learns to update its Q-function by minimizing the difference between the predicted Q-value and the actual Q-value obtained from the Bellman equation. The Bellman equation is a recursive formula that relates the Q-value of a state-action pair to the Q-value of the next state-action pair. Overall, the deep Q-network is an effective and powerful tool for learning efficient scheduling policies in real-time systems, and can be used in conjunction with other reinforcement learning algorithms such as PPO 338 to achieve even better performance.

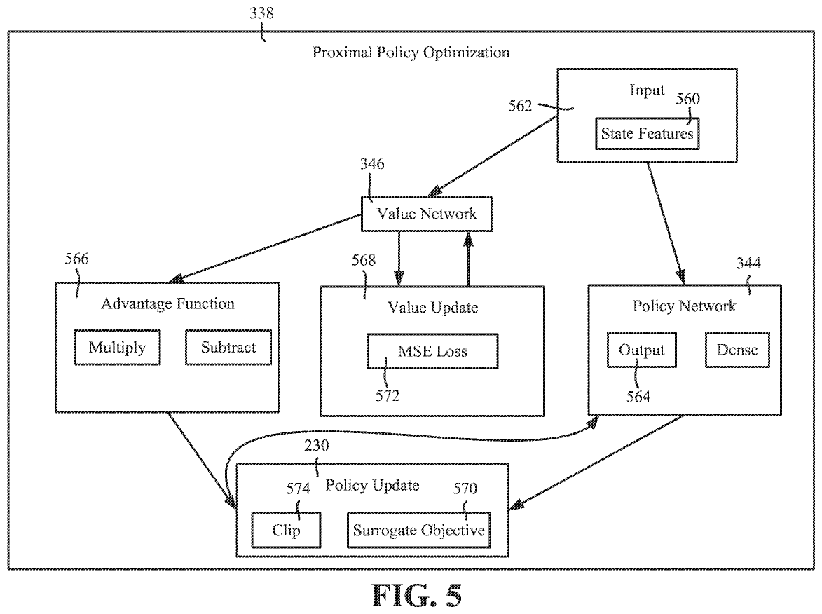

A neural network architecture for proximal policy optimization 338 is depicted in FIG. 5. In general, the proximal policy optimization 338 algorithm is a model-free, online policy optimization algorithm used in reinforcement learning. Similar to the DQN 336, the proximal policy optimization 338 network uses a neural network to approximate the policy function.

The input to the proximal policy optimization 338 neural network includes the current state of the system, similar to the input for the DQN 336 described with reference to FIG. 4. The proximal policy optimization 338 network typically includes two subnetworks, the policy network 344 and the value network 346.

The policy network 344 is responsible for taking the current state (block 560) of the system as input 562 and outputting a probability distribution over the possible actions that can be taken. The output 564 of the policy network 344 is used to determine the action that the system should take at the current time step.

The value network 346 estimates the expected value of the current state, which is used to evaluate the quality of the current policy. The output of the value network 346 is used to compute the advantage function 566, which measures the expected improvement of taking a particular action in the current state compared to the current policy.

During training, the policy optimization 338 network uses a variant of stochastic gradient descent to update the policy network 344 and value network 346 (e.g., via block 568). The algorithm uses a surrogate objective function 570 to update the policy network, which is designed to ensure that the policy remains close to the current policy. The value network is updated (block 568) using the mean squared error (MSE, block 572) between the estimated value and the actual value.

The policy optimization 338 algorithm also uses a technique called “clipping” (block 574) as part of the policy update 230 to ensure that the policy update 230 does not change too much at each iteration. This helps to prevent large policy updates that could destabilize the learning process.

In one example scenario, the AI scheduler need not immediately or fully replace existing scheduling, instead being implemented via progressive training and integration. One approach for using the AI scheduler is to start with traditional scheduling approaches such as first come first serve, earliest deadline first scheduling, partition scheduling, semi-partitioned scheduling, deadline-monotonic scheduling, and/or rate-monotonic scheduling. As the system collects data and gains experience, it can gradually start incorporating the AI scheduler more and more into its decision-making process.

Before going online, the AI scheduler can be trained a priori using simulations. This allows the scheduler to learn from a wide range of scenarios and to experiment with different scheduling policies without affecting the real-time system. The training process can be accelerated using hardware accelerators such as graphics processing units (GPUs) or tensor processing units (TPUs), which can perform matrix operations required for neural network training much faster than traditional CPUs.

Once the AI scheduler has been trained, it can be deployed in the real-time system and continue to learn and improve over time as it interacts with the environment. This approach provides a relatively safe and controlled way to integrate the AI scheduler into a real-time system, while also ensuring that the system can continue to operate using traditional scheduling approaches if necessary. The progressive training and integration scenario also allows for continuous learning and improvement, without the risk of disrupting the system during the training process.

As the AI scheduler becomes more integrated into the system, the scheduler can gradually take on more responsibility for scheduling decisions. During this process, the scheduler can continue to collect data and learn from its interactions with the environment, allowing the scheduler (including the resource allocation module) to continuously improve its policies and make more effective scheduling decisions.

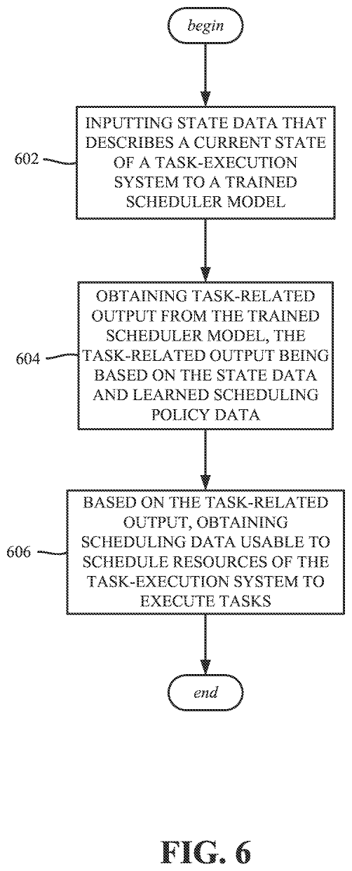

One or more aspects can be embodied in a system, such as represented in the example operations of FIG. 6, and for example can include a memory that stores computer executable components and/or operations, and a processor that executes computer executable components and/or operations stored in the memory. Example operations can include operation 602, which represents inputting state data that describes a current state of a task-execution system to a trained scheduler model. Example operation 604 represents obtaining task-related output from the trained scheduler model, the task-related output being based on the state data and learned scheduling policy data. Example operation 606 represents based on the task-related output, obtaining scheduling data usable to schedule resources of the task-execution system to execute tasks.

The state data can include at least one of: respective priority levels of a group of respective tasks, respective remaining execution times of the respective tasks of the group of respective tasks, or resource-related data of resources currently being used by the task-execution system.

The trained scheduler model can include a global artificial intelligence scheduler module configured to output scheduling data that allocates task-execution system resources to the tasks based on resource availability data, task priority data, and per-task resource needs, and a local artificial intelligence scheduler module coupled to obtain the scheduling data from the global artificial intelligence scheduler module and assign processors to the tasks based on the per-task resource needs.

Further operations can include obtaining, by a resource allocation module, the scheduling data, and allocating, by the resource allocation module, the resources to the tasks based on the scheduling data.

Further operations can include a recurrent learning module that learns the learned scheduling policy data, and wherein the recurrent learning module can include a proximal policy optimization model and a deep-Q network.

The deep-Q network can output action values comprising Q-values representative of candidate actions based on the current state data.

The proximal policy optimization model can output the scheduling policy data. The proximal policy optimization model can include a policy subnetwork and a value subnetwork; the policy network can output a probability distribution over candidate actions based on the state data, and the value network can estimate an expected value of the current state for use in evaluating a quality metric of current policy data.

The task-execution system can include a real-time control system. The real-time control system can include at least one of: a test control system, a measurement control system, a manufacturing control system, a power generation control system, a transportation control system, an industrial automation control system or a process control system.

The task-execution system can include at least one of: a network management system, a network optimization system, or a function of an edge computing system.

Further operations can include updating the learned scheduling policy data based on measured performance data of the task-execution system.

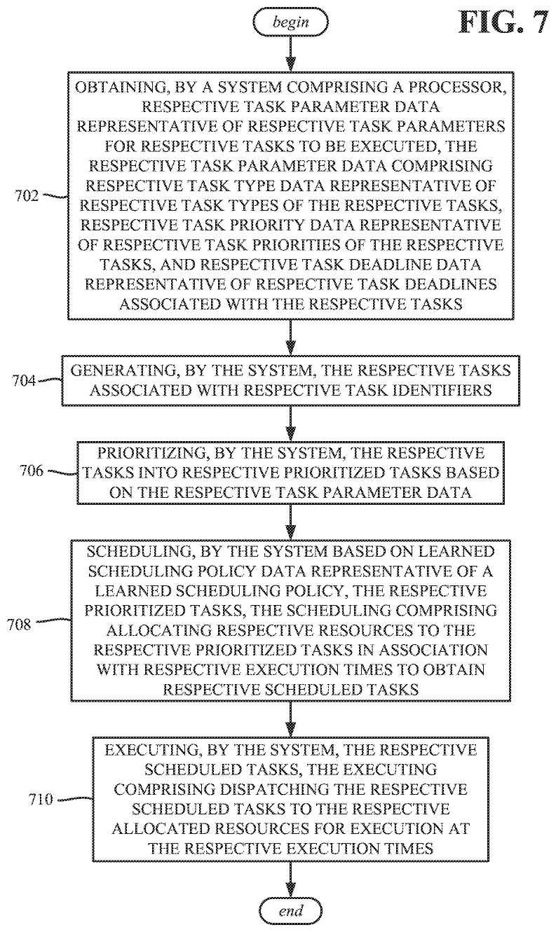

One or more example aspects, such as corresponding to example operations of a method, are represented in FIG. 7. Example operation 702 represents obtaining, by a system comprising a processor, respective task parameter data representative of respective task parameters for respective tasks to be executed, the respective task parameter data comprising respective task type data representative of respective task types of the respective tasks, respective task priority data representative of respective task priorities of the respective tasks, and respective task deadline data representative of respective task deadlines associated with the respective tasks. Example operation 704 represents generating, by the system, the respective tasks associated with respective task identifiers. Example operation 706 represents prioritizing, by the system, the respective tasks into respective prioritized tasks based on the respective task parameter data. Example operation 708 represents scheduling, by the system based on learned scheduling policy data representative of a learned scheduling policy, the respective prioritized tasks, the scheduling comprising allocating respective resources to the respective prioritized tasks in association with respective execution times to obtain respective scheduled tasks. Example operation 710 represents executing, by the system, the respective scheduled tasks, the executing comprising dispatching the respective scheduled tasks to the respective allocated resources for execution at the respective execution times.

Further operations can include monitoring, by the system, the execution of the respective scheduled tasks, and, based on a result of the monitoring, outputting, by the system, updated learned scheduling policy data representative of an updated learned scheduling policy.

Scheduling the respective prioritized tasks can include selecting, by a global artificial intelligence scheduler, a local artificial intelligence scheduler, and assigning, by the local artificial intelligence scheduler, respective processors to the respective scheduled tasks.

Scheduling of the respective prioritized tasks further can include mapping the respective task parameter data to respective actions based on the learned scheduling policy data.

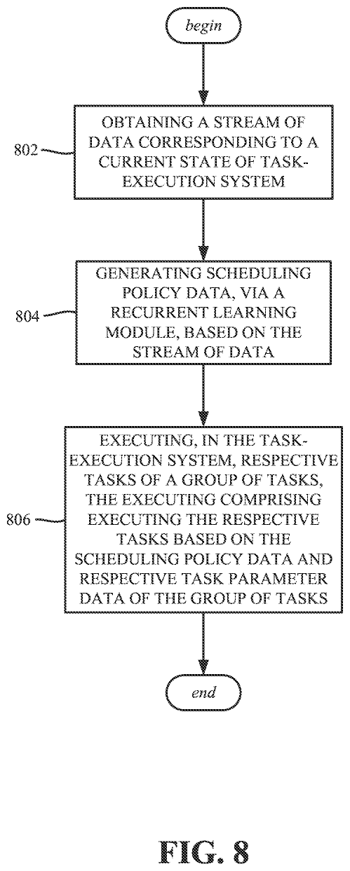

FIG. 8 summarizes various example operations, e.g., corresponding to a machine-readable medium, comprising executable instructions that, when executed by a processor, facilitate performance of operations. Example operation 802 represents obtaining a stream of data corresponding to a current state of task-execution system. Example operation 804 represents generating scheduling policy data, via a recurrent learning module, based on the stream of data. Example operation 806 represents executing, in the task-execution system, respective tasks of a group of tasks, the executing comprising executing the respective tasks based on the scheduling policy data and respective task parameter data of the group of tasks.

Obtaining the stream of data can include obtaining resource data representative of available resources of the task-execution system, and obtaining respective task data representative of the respective tasks to perform; executing the respective tasks based on the scheduling policy data can include allocating respective resources of the available resources to perform the respective tasks of the group of tasks at respective execution times.

Further operations can include monitoring the performance of the task-execution system with respect to executing the respective tasks.

Further operations can include updating the scheduling policy data based on the monitoring of the performance of the task-execution system.

As can be seen, the technology described herein facilitates an artificial intelligence scheduler for real-time systems. In one implementation, the AI scheduler is based on a recurrent learning model, such as one that incorporates both deep Q-networks and proximal policy optimization algorithms to learn efficient scheduling policies for real-time systems. By preprocessing data, performing reinforcement learning, and updating policies, the scheduler can optimize for a variety of system aspects, including avoiding deadlocks, minimizing blocking, avoiding priority inversion, and reducing starvation. The AI scheduler can start by employing traditional scheduling approaches and gradually integrate the learned policies as they become more refined through a priori training using simulations. With its ability to learn from experience, the AI scheduler improves its policies over time and adapts to changing system requirements. The technology described herein thus has the potential to significantly improve the efficiency and reliability of real-time systems across a range of domains.

The AI-based approach of the technology described herein facilitates more optimally scheduling real-time systems with multiple CPUs and multi-unit resources, such as GPUs, TPUs, and DPUs. The AI scheduler can be trained using simulations, enabling it to generalize to real-world scenarios. This approach can be adapted to various systems, including regular systems and orchestration systems, including, but not limited to aviation, aerospace, automotive, manufacturing, and telecommunications, industrial automation, process control scientific research, control systems for manufacturing and process automation, power generation, transportation, building technologies, performance materials, safety, process management, climate technologies, commercial and residential solutions, power generation, oil and gas production, network management and optimization, and edge computing solutions that ensure efficient use of available computing resources.

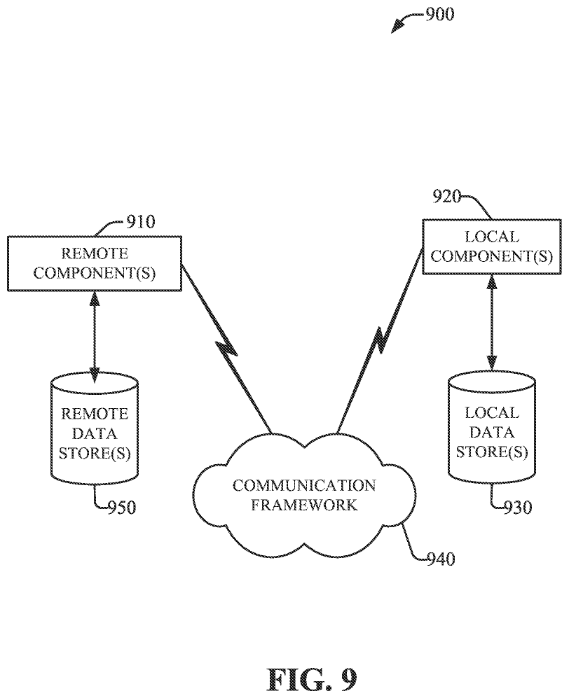

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise an automatic scaling component and/or programs that communicate/use the remote resources 910, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

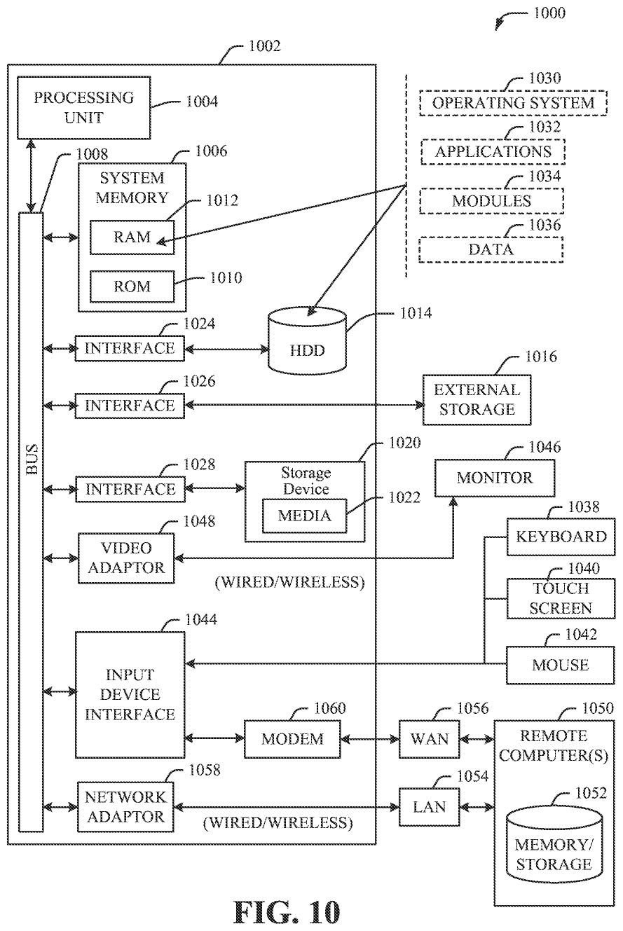

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), and can include one or more external storage devices 1016 (e.g., a magnetic floppy disk drive (FDD) 1016, a memory stick or flash drive reader, a memory card reader, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014.

Other internal or external storage can include at least one other storage device 1020 with storage media 1022 (e.g., a solid state storage device, a nonvolatile memory device, and/or an optical disk drive that can read or write from removable media such as a CD-ROM disc, a DVD, a BD, etc.). The external storage 1016 can be facilitated by a network virtual machine. The HDD 1014, external storage device(s) 1016 and storage device (e.g., drive) 1020 can be connected to the system bus 1008 by an HDD interface 1024, an external storage interface 1026 and a drive interface 1028, respectively.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1094 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
inputting state data that describes a current state of a task-execution system to a trained scheduler model;
obtaining task-related output from the trained scheduler model, the task-related output being based on the state data and learned scheduling policy data; and
based on the task-related output, obtaining scheduling data usable to schedule resources of the task-execution system to execute tasks.

2. The system of claim 1, wherein the state data comprises at least one of: respective priority levels of a group of respective tasks, respective remaining execution times of the respective tasks of the group of respective tasks, or resource-related data of resources currently being used by the task-execution system.

3. The system of claim 1, wherein the trained scheduler model comprises a global artificial intelligence scheduler module configured to output scheduling data that allocates task-execution system resources to the tasks based on resource availability data, task priority data, and per-task resource needs, and a local artificial intelligence scheduler module coupled to obtain the scheduling data from the global artificial intelligence scheduler module and assign processors to the tasks based on the per-task resource needs.

4. The system of claim 1, wherein the operations further comprise obtaining, by a resource allocation module, the scheduling data, and allocating, by the resource allocation module, the resources to the tasks based on the scheduling data.

5. The system of claim 1, wherein the operations further comprise a recurrent learning module that learns the learned scheduling policy data, and wherein the recurrent learning module comprises a proximal policy optimization model and a deep-Q network.

6. The system of claim 5, wherein the deep-Q network outputs action values comprising Q-values representative of candidate actions based on the current state data.

7. The system of claim 5, wherein the proximal policy optimization model outputs the scheduling policy data.

8. The system of claim 5, wherein the proximal policy optimization model comprises a policy subnetwork and a value subnetwork, wherein the policy network outputs a probability distribution over candidate actions based on the state data, and wherein the value network estimates an expected value of the current state for use in evaluating a quality metric of current policy data.

9. The system of claim 1, wherein the task-execution system comprises a real-time control system.

10. The system of claim 9, wherein the real-time control system comprises at least one of: a test control system, a measurement control system, a manufacturing control system, a power generation control system, a transportation control system, an industrial automation control system or a process control system.

11. The system of claim 1, wherein the task-execution system comprises at least one of: a network management system, a network optimization system, or a function of an edge computing system.

12. The system of claim 1, wherein the operations further comprise updating the learned scheduling policy data based on measured performance data of the task-execution system.

13. A method, comprising:
obtaining, by a system comprising a processor, respective task parameter data representative of respective task parameters for respective tasks to be executed, the respective task parameter data comprising respective task type data representative of respective task types of the respective tasks, respective task priority data representative of respective task priorities of the respective tasks, and respective task deadline data representative of respective task deadlines associated with the respective tasks;
generating, by the system, the respective tasks associated with respective task identifiers;
prioritizing, by the system, the respective tasks into respective prioritized tasks based on the respective task parameter data;
scheduling, by the system based on learned scheduling policy data representative of a learned scheduling policy, the respective prioritized tasks, the scheduling comprising allocating respective resources to the respective prioritized tasks in association with respective execution times to obtain respective scheduled tasks; and
executing, by the system, the respective scheduled tasks, the executing comprising dispatching the respective scheduled tasks to the respective allocated resources for execution at the respective execution times.

14. The method of claim 13, further comprising monitoring, by the system, the execution of the respective scheduled tasks, and, based on a result of the monitoring, outputting, by the system, updated learned scheduling policy data representative of an updated learned scheduling policy.

15. The method of claim 13, wherein the scheduling of the respective prioritized tasks comprises selecting, by a global artificial intelligence scheduler, a local artificial intelligence scheduler, and assigning, by the local artificial intelligence scheduler, respective processors to the respective scheduled tasks.

16. The method of claim 13, wherein the scheduling of the respective prioritized tasks further comprises mapping the respective task parameter data to respective actions based on the learned scheduling policy data.

17. A non-transitory machine-readable medium, comprising executable instructions that, when executed by a processor, facilitate performance of operations, the operations comprising:
obtaining a stream of data corresponding to a current state of task-execution system;
generating scheduling policy data, via a recurrent learning module, based on the stream of data; and
executing, in the task-execution system, respective tasks of a group of tasks, the executing comprising executing the respective tasks based on the scheduling policy data and respective task parameter data of the group of tasks.

18. The non-transitory machine-readable medium of claim 17, wherein the obtaining of the stream of data comprises obtaining resource data representative of available resources of the task-execution system, and obtaining respective task data representative of the respective tasks to perform, and wherein the executing of the respective tasks based on the scheduling policy data comprises allocating respective resources of the available resources to perform the respective tasks of the group of tasks at respective execution times.

19. The non-transitory machine-readable medium of claim 17, wherein the operations further comprise monitoring the performance of the task-execution system with respect to executing the respective tasks.

20. The non-transitory machine-readable medium of claim 19, wherein the operations further comprise updating the scheduling policy data based on the monitoring of the performance of the task-execution system.
